(19) United States
(12) Patent Application Publication
(10) Pub. No.: US 2026/0204010 A1
(43) Pub. Date: Jul. 16, 2026

(54) SYSTEMS AND METHODS OF DYNAMICALLY PROVIDING CONSISTENT INFORMATION ACROSS DIFFERENT PLATFORMS

(71) Applicant: Salesforce, Inc., San Francisco, CA (US)

(72) Inventor: Natalija Pavic, Toronto (CA)

(21) Appl. No.: 19/024,467

(22) Filed: Jan. 16, 2025

(51) Int. Cl. G06T 17/00

(52) U.S. Cl. CPC G06T 17/00

(57) ABSTRACT

Systems and methods are provided for generating, at a server, a product digital twin that is a virtual representation of a product, where the product digital twin is dynamically updatable. A content digital twin may be generated that is a virtual representation of content for the product that is dynamically updatable. The server may receive data from at least one source, and generating updates for the product digital twin and/or the content digital twin based on the received data. The generated updates may be transmitted to a plurality of different platforms.

### BACKGROUND

Currently, content descriptions for products on a web site or application are typically static descriptions that do not change based on a particular user, or based on interactions with a user. Also, there can be differences in product information across different platforms websites, apps, social media sites, email messages, and the like, such that the product information is not consistent across the different platforms.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIGS. 1-2 show an example method of providing consistent information across different platforms that may be personalized for a user according to implementations of the disclosed subject matter.

FIGS. 3A-3C show an example operations for providing consistent information across different platforms according to implementations of the disclosed subject matter.

FIG. 3D shows an example system which may perform the example method of FIGS. 1-2 and/or the operations shown in FIGS. 3A-3C according to implementations of the disclosed subject matter.

FIG. 4 shows an example computer system to perform the example methods of FIGS. 1-2 and/or the operations of the information flow shown in FIGS. 3A-3C, and may include the example system of FIG. 3D according to implementations of the disclosed subject matter.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

The inventive concept relates to providing dynamically updated information that is consistent across different platforms (e.g., websites, apps, social media sites, email messages, etc.). The inventive concept generates a product digital twin that is that is a dynamically updatable virtual representation of a product, and a content digital twin that is a dynamically updatable content for the product. Data is collected from different sources (e.g., user interactions with websites, apps, products, social media posts, etc.), and the product digital twin and/or the content digital twin are updated based on the data. These updates may allow for personalization of information (e.g., product information, content, educational material, etc.) to one or more users. The product digital twin and the content digital twin may allow for consistency of information presented to a user or groups of users across different platforms.

Implementations of the disclosed subject matter may use natural language processing (NLP), machine learning (ML), and/or artificial intelligence (AI) systems to generate or modify content in real time based on user input, contextual triggers, and/or predicted engagement outcomes. For example, an ML system may be used to analyze user data to tailor the content to individual users or groups of users. The ML system may continually learn from each interaction, and may generate content that may be relevant for the user based on the interactions. In another example, natural language processing may be used to change structure, style, tone, style, and/or language of the content to tailor it to a user or group of users.

The digital twins (i.e., the product digital twin and the content digital twin) may evolve as the system gathers more data, and may be updated to reflect changing user preferences. The digital twins of the disclosed subject matter may provide personalized and/or adaptive content.

Currently, product-related content may be difficult to find on various endpoints and/or platforms, and the content may not be consistent among the endpoints and/or platforms. Users often engage with content across different channels, and there is frequently a lack of coherence for content across the different channels. There may be a lack of personalized user experience for content, and there may be low engagement and high drop-off rates for users of e-learning, education, commerce, and streaming platforms when a user does not have content that aligns with their interests. Presently, to have separate content created and available for different users requires significant computing and data storage resources. Content currently provided to users is not optimized in real time. That is, presently provided static content is not capable of being modified based on collected data to generate a custom experience for the user.

Implementations of the disclosed subject matter improve upon current systems which have static content delivery systems which can have inconsistencies over different platforms. In the disclosed subject matter, a virtual representation of the content may be created that dynamically changes in response to user behavior, preferences, and/or contextual data. By continuously analyzing user interactions and/or integrating external data inputs, systems and methods of the disclosed subject matter may adapt narrative structure of content provided to a user, which may provide tailored experiences to the user that evolve in real-time. Implementations of the disclosed subject matter may allow for content formats to be optimized across multiple channels and/or platforms.

Implementations of the disclosed subject matter may be used in connection with one or more products, and/or may be used for interactive storytelling, personalized media streaming, immersive gaming, e-learning and/or education, and/or information services to provide engaging, relevant, and/or customized content to a particular user or group of users. For example, implementations of the disclosed subject matter may be used to create personalized viewing experiences for users for streaming services and/or for digital publishing content. In another example, implementations of the disclosed subject matter may be used to provide a tailored learning path for a user that adapts to the user’s learning progress and/or learning preferences. In yet another example, implementations of the disclosed subject matter may provide product recommendations and/or personalized content (e.g., product information, product description, images, and the like) relating to products.

Implementations of the disclosed subject matter provide dynamically updated information that is consistent across different platforms (e.g., websites, apps, social media sites, email messages, etc.). Implementations of the disclosed subject matter generate a product digital twin that may be a dynamically updatable virtual representation of a product, and a content digital twin that may be a dynamically updatable content for the product. Data may be collected from different sources (e.g., user interactions with websites, apps, products, social media posts, and the like), and the product digital twin and/or the content digital twin may be updated based on the data. These updates may allow for personalization of information (e.g., product information, content, educational material, and the like) to one or more users. In some implementations, the systems and methods of the disclosed subject matter may provide personalized experiences based on individual preferences, past interaction data, purchase and/or viewing history, or the like. The product digital twin and/or the content digital twin may allow for consistency of information presented to a user or groups of users across different platforms.

Implementations of the disclosed subject matter may use natural language processing (NLP), machine learning (ML), and/or generative artificial intelligence (AI) to generate or modify content in real time based on user input, contextual triggers, and/or predicted engagement outcomes. For example, machine learning (ML) may be used to analyze user data to tailor the content to individual users or groups of users. The ML system may continually learn from each interaction, and may generate content that may be relevant for the user based on the interactions. In another example, NLP may be used to change structure, style, tone, style, and/or language of the content to tailor it to a user or group of users.

The digital twins (i.e., the product digital twin and the content digital twin) may evolve as the system gathers more data, and may be updated to reflect changing user preferences. The digital twins of the disclosed subject matter may provide personalized and/or adaptive content.

Currently, content (e.g., product descriptions, educational information, and the like) may be difficult to find on various endpoints and/or platforms, and the content may not be consistent among the endpoints and/or platforms. Users frequently engage with content across different channels, and there is frequently a lack of coherence for content across the different channels. There may be a lack of personalized user experience for content, and there may be low engagement and high drop-off rates for users of e-learning, education, commerce, and streaming platforms when a user does not have content that aligns with their interests. Presently, to have separate content created and available for different users requires significant computing and data storage resources. Content currently provided to users is not optimized in real time. That is, presently provided static content is not capable of being modified based on collected data to generate a custom experience for the user.

Implementations of the disclosed subject matter improve upon current systems which have static content delivery systems which typically have inconsistencies over different platforms. In the disclosed subject matter, a virtual representation of the content may be created that dynamically changes in response to user behavior, preferences, and/or contextual data. By continuously analyzing user interactions and/or integrating external data inputs, systems and methods of the disclosed subject matter may adapt the narrative structure of content provided to a user, which may provide tailored experiences to the user that evolve in real-time. Implementations of the disclosed subject matter may allow for content formats to be optimized across multiple channels and/or platforms.

Implementations of the disclosed subject matter may improve upon traditional content management systems (CMS), which are software applications that help users create, store, manage, and modify digital content. CMSs are often used with websites that frequently publish or update content. The content digital twin of the disclosed subject matter may dynamically adapt (e.g., modify and/or generate) content in real-time based on user interactions, contextual data, and/or external inputs. By using at least the content digital twin or the digital twin system (i.e., the product digital twin and the content digital twin), the disclosed subject matter may provide a personalized, consistent, and/or evolving experience across content platforms for a user. In contrast, a traditional CMS provides tools for static content creation, storage, and manual updates which often require user and/or operator intervention to maintain relevance and/or consistency. Typical CMSs focuses on organizing and publishing predefined content. The digital twin of the disclosed subject matter continuously refines and/or personalizes content to optimize engagement and/or relevance, as discussed in detail below.

The digital twin system described throughout that includes the product digital twin and the content digital twin may have advantages over current CMSs or related systems. For example, the digital twin system may have dynamic adaptability, which may update and/or evolve content based on user behavior and/or preferences without manual intervention from a system operator or others. The digital twin system may provide real-time personalization, where content may be tailored individuals or groups using AI and/or ML. This real-time personalization may provide information and/or content that is relevant to the user, and may increase user engagement with the information and/or content.

The digital twin system described throughout may provide improvements over current systems with regards to cross-platform consistency. That is, the digital twin system may provide consistent content across different platforms (e.g., websites, applications (apps), social media, emails, and the like) where content may be published, and/or may optimize content for the platform.

The digital twin system described throughout may provide improvements over current systems by having automated feedback integration. In this arrangement, content may be adapted (e.g., modified and/or generated) using real-time feedback from user interactions and/or contextual triggers. This improves over current systems, where manual updates to content are typically made periodically, where such changes are not real-time changes based on user interactions and/or contextual triggers.

The digital twin system may provide improved scalability over current CMS systems or the like. The digital twin system may handle complex, evolving content scenarios across one or more channels, in contrast to the manual CMS updates. For example, data may be received from channels (e.g., one or more platforms, one or more sources of user interaction and/or data, and the like) in response to published content, and the digital twin system may modify, update, and/or generate new content in response to and/or based on the received data.

The digital twin system of the disclosed subject matter may provide increased engagement with users with information and/or content when compared to current systems. That is, as information and/or content is provided to the user that has increased relevance, there may be increased retention of users, and there may be fewer frustrated users who leave for other platforms who have difficulty finding relevant information and/or content.

The digital twin system of the disclosed subject matter may improve over current CMSs, as the digital twin system may be configured to adapt to new data sources, platforms, and/or technologies to continue to provide personalized content, recommendations, and/or consistent content across different platforms, unlike traditional CMSs which require software upgrades or plugins. This may increase up-time of the digital twin system while continuing to provide relevant information to a user or group of users.

Implementations of the disclosed subject matter may be used in connection with one or more products, and/or may be used for interactive storytelling, personalized media streaming, immersive gaming, e-learning, and/or education to provide engaging, relevant, and customized content to a particular user or group of users. For example, implementations of the disclosed subject matter may be used to create personalized viewing experiences for users for streaming services and/or for digital publishing content. In another example, implementations of the disclosed subject matter may be used to provide a tailored learning path for a user that adapts to the user’s learning progress and/or learning preferences. In yet another example, implementations of the disclosed subject matter may provide product recommendations and/or personalized content (e.g., product information, product description, images, and the like) relating to products.

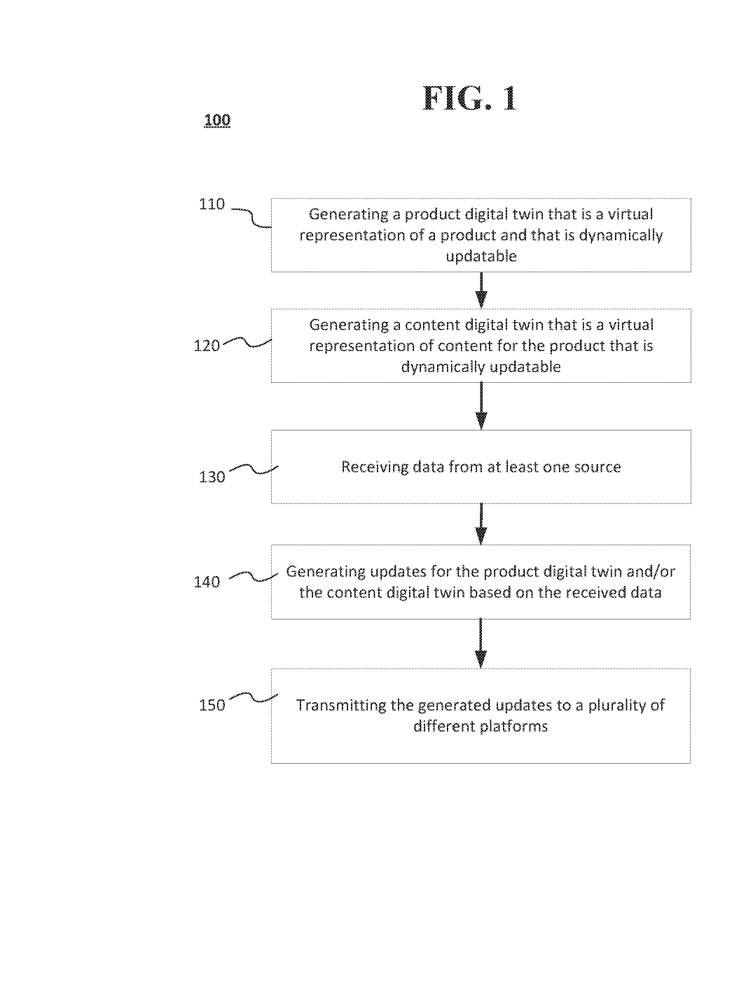

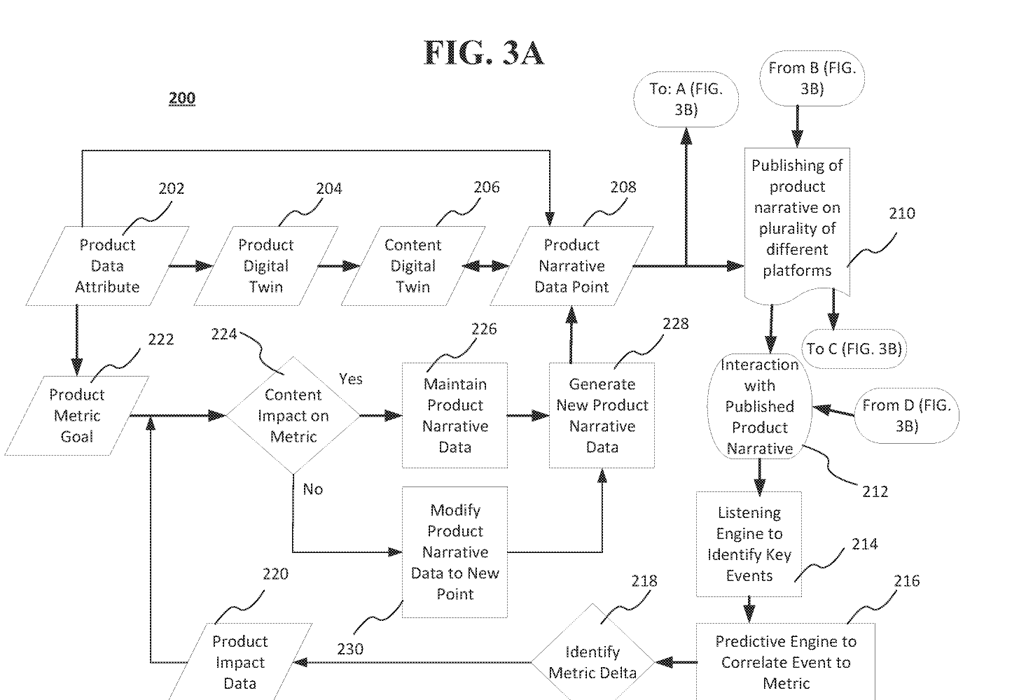

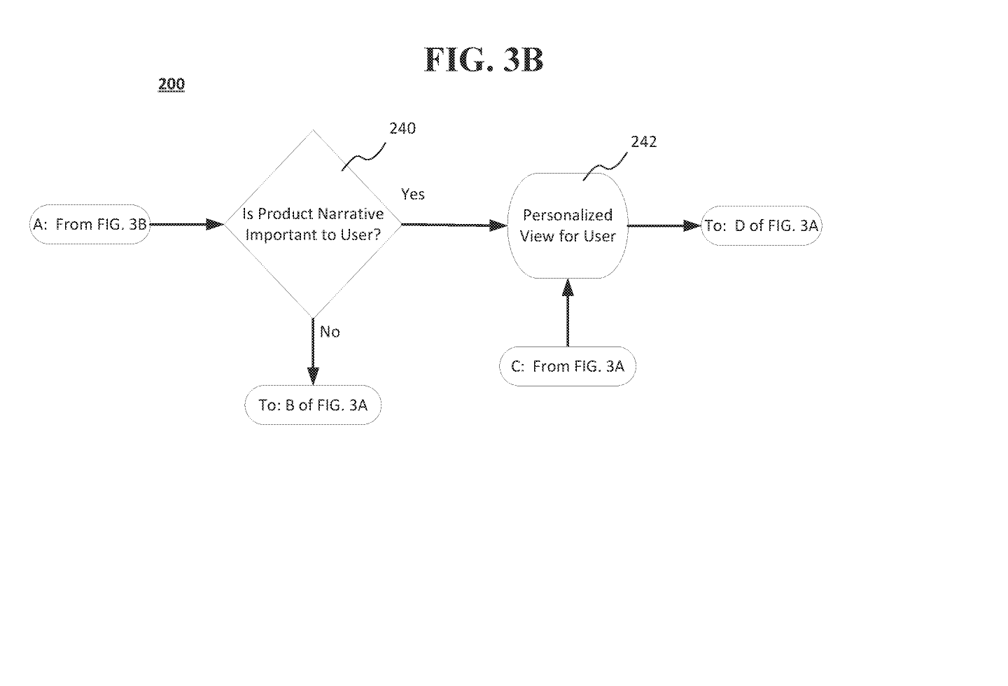

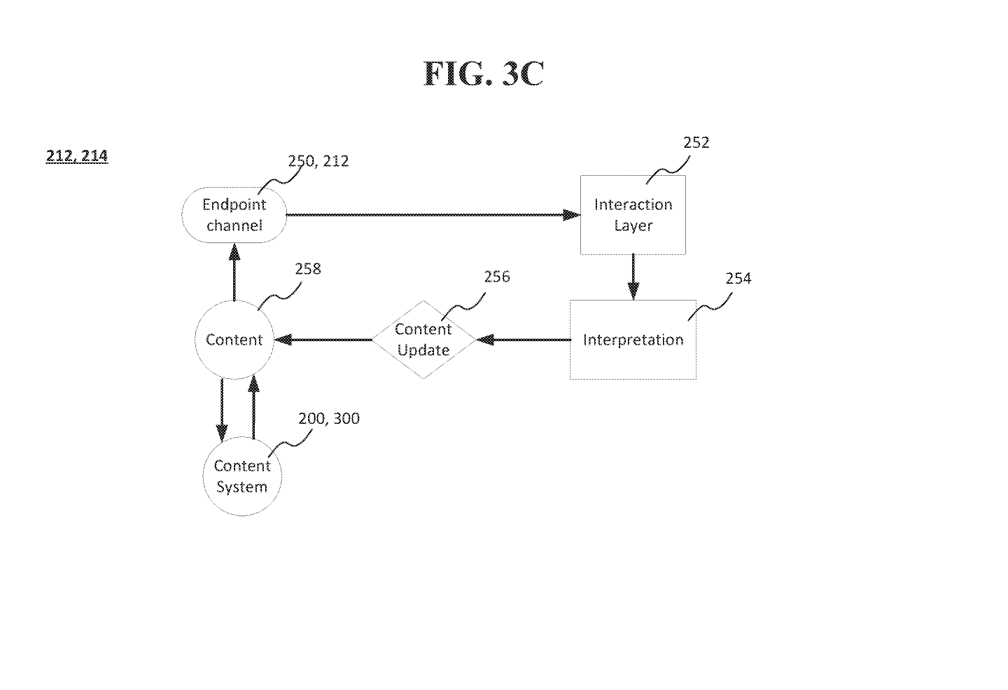

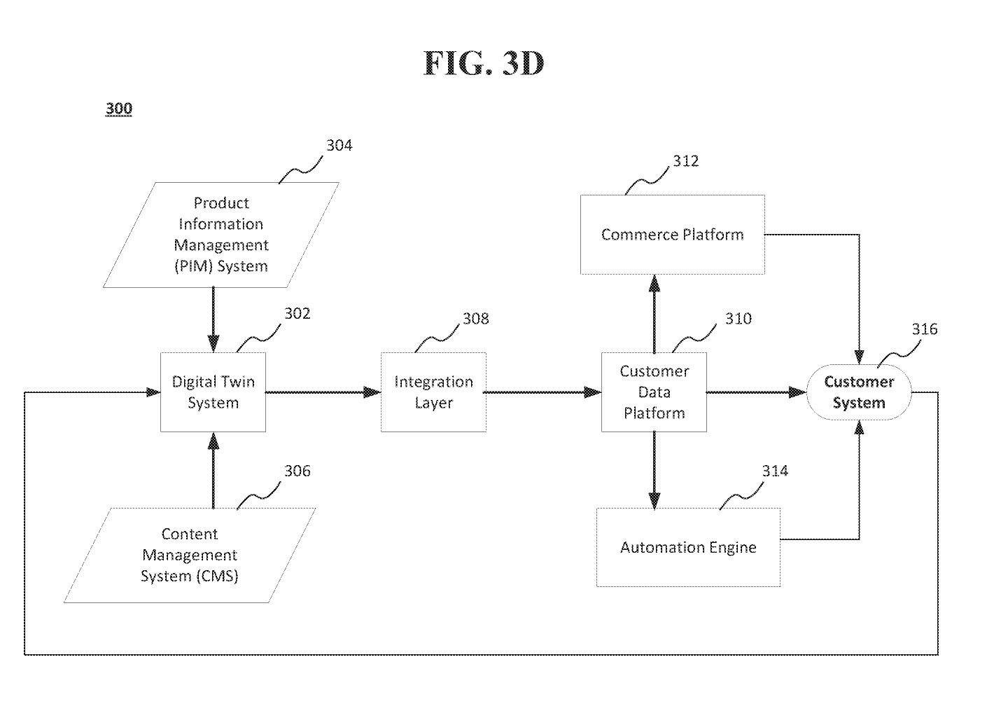

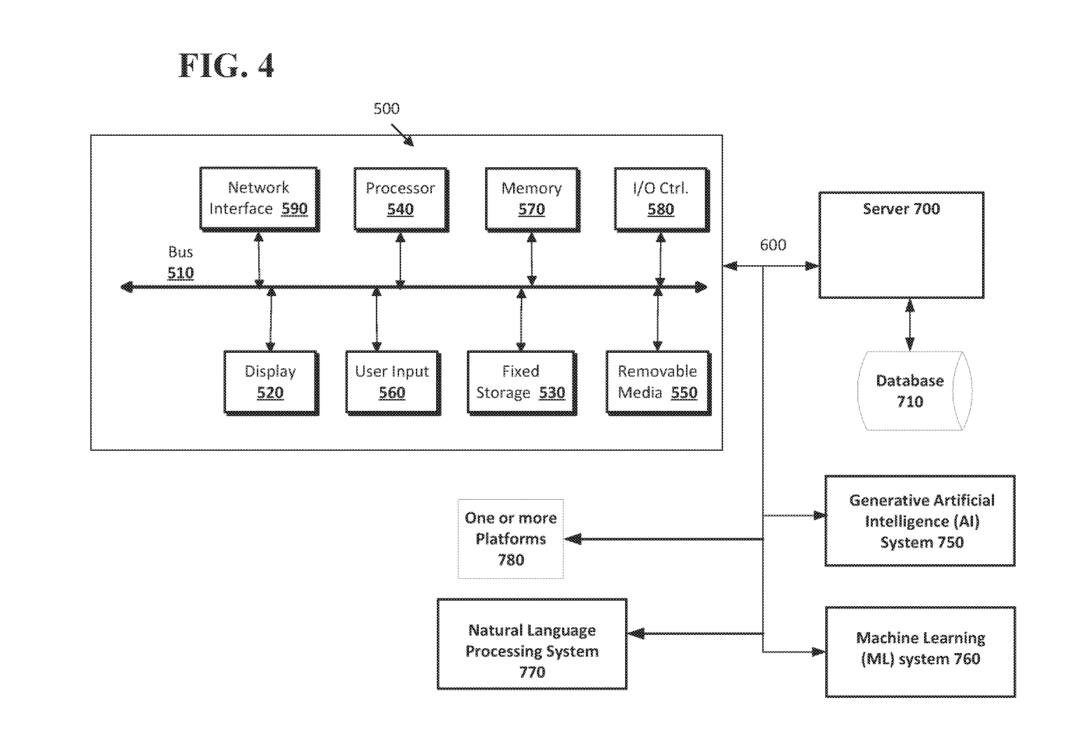

FIG. 1 shows method 100 for providing consistent information across different platforms that may be personalized for a user according to implementations of the disclosed subject matter. At operation 110, a server (e.g., server 700 shown in FIG. 4) may generate a product digital twin (e.g., product digital twin 204 shown in FIG. 3A) of a digital twin system (e.g., digital twin system 302 shown in FIG. 3D) that may be a virtual representation of a product, where the product digital twin is dynamically updatable as described below in connection with FIG. 3D. For example, a product information management system (PIM) and/or other information sources may provide updates of product attributes to the product digital twin of the digital twin system.

At operation 120, the server may generate a content digital twin (e.g., content digital twin 206 shown in FIG. 3A) that may be a virtual representation of content for the product that is dynamically updatable. The content digital twin may mirror one or more pieces of content (e.g., for a product, and educational resource, or the like), and may be a virtual model that tracks the lifecycle of the content, which may include the initial creation of the content, deployment of the content to one or more different platforms, user interactions with the content, modifications to the content, and the like. In some implementations, the content digital twin may store metadata about the content, such as its format, target user or group of users, user engagement statistics, version history, and the like. The metadata may be used in determining updates and/or modifications to the content (e.g., generating new product narrative data at operation 228 shown in FIG. 3A). That is, user interactions and/or engagement metrics from one or more sources may be transmitted to the digital twin system as a feedback loop that allows for content and/or narrative of the content digital twin to be continuously updated. This updating may provide increased personalization for a user over time. For example, as shown in FIG. 3D and described below, a customer system 316 that collects data from a variety of sources may be part of a feedback loop that provides information to the digital twin system 302, which may lead to the content and/or narrative being updated.

At operation 130, the server may receive data from at least one source. The received data may be include user interactions, behavioral analytics, contextual information (e.g., location of the user, information regarding the device (e.g. computer 500) of the user, time of day, and the like), external data feeds, market trend information, social media data, product data from a product information management (PIM) system (e.g., PIM 304 shown in FIG. 3D, content data from a content management system (CMS) (e.g., CMS 306 shown in FIG. 3D), or the like. The data may be received and/or collected in real-time from one or more sources.

At operation 140, the server may generate updates for the product digital twin and/or the content digital twin based on the received data. In some implementations, the server may update the digital product twin based on data received from an actual product that the digital product twin is a virtual representation of, and/or product simulation data. For example, as discussed below in connection with FIG. 3D, a product information management system (PIM) (e.g., PIM 304) may provide updated product data to the digital twin system (e.g., digital twin system 302) that may include the product digital twin.

In some implementations, the server may generate updates for the content digital twin based on the received data when the received data meets a predetermined metric or threshold. For example, as described below in connection FIG. 3A, it may be determined whether content of the content digital twin is having an impact on a product metric goal, and a product narrative may be modified and/or a new product narrative may be generated to increase progress towards the product metric goal.

In some implementations, the server may generate updates for the content digital twin based on received data that is real-time data, user interaction data, and/or contextual information, or the like. For example, as discussed below in connection with FIGS. 3A-3C, interactions with a published narrative for the content digital twin may be monitored, and a listening engine (e.g., listening engine 214 shown in FIG. 3A) may be used to identify key events from the interactions. The identified key events may be used to modify the product narrative and/or generate a new product narrative.

In some implementations, an artificial intelligence system (e.g., generative artificial intelligence (AI) system 750 shown in FIG. 4), machine learning system (e.g., machine learning (ML) system 760 shown in FIG. 4), and/or natural language processing system 770 that is part of or communicatively coupled to the server may generate the updates for the content digital twin based on at least a portion of the received data. For example, the AI system 750, the ML system 760, and/or the natural language processing system 770 may be used to process the received data to determine preferences, behavior patterns from interactions, and/or performance metrics, which may be used to generate the updates for the content digital twin. In this example, the generated updates for the content may align the content with the preferences of a user to present more relevant content for a user or group of users. In another example, content and/or a narrative may be updated, changed, or modified based on received user input data and/or contextual data that is received, and/or based on engagement outcomes predicted by the AI system 750 and/or the ML system 760. In one example, the AI system 750 and/or the ML system 760 may predict user at least one user engagement trend (e.g., based on data received from the at least one source), and adjust a narrative for a product to enhance relevance of the product narrative for the user. This anticipatory approach to narrative generation is an improvement over traditional static content delivery systems. In another example, a predictive engine may be used to correlate key interaction events with a product metric goal as described below in connection with operation 216 of FIG. 3A.

In some implementations, the AI system 750, ML system 760, and/or the natural language processing system 770 may enable dynamic changes to a narrative for a product based on detected user behavior, user preferences, and/or external factors from data collected from one or more data sources. For example, as discussed below in connection with FIGS. 3A-3C, interactions with a published narrative for the content digital twin may be monitored to identify key events from the interactions. The identified key events may be used to modify the product narrative and/or generate a new product narrative.

In some implementations, the server may personalize the content digital twin for a user or a group of users based on the received data. As described below in connection with FIGS. 3A-3C, a product narrative data point may be used to personalize content for the user. The product narrative data point may be modified based on a product metric goal, and a new product narrative may be generated to target and/or personalize content for the user.

At operation 150, the server may transmit the generated updates to a plurality of different platforms. The plurality of different platforms may include websites, social media sites, mobile applications, and/or email messages. In some implementations, the server may format the generated updates for the plurality of different platforms. For example, the server may adapt the content for different platforms, channels, and/or devices. That is, the content may be customized to suit different platforms, such as websites, mobile apps, social media, and/or email, and the like (e.g., as described below in connection with operation 210 of FIG. 3A).

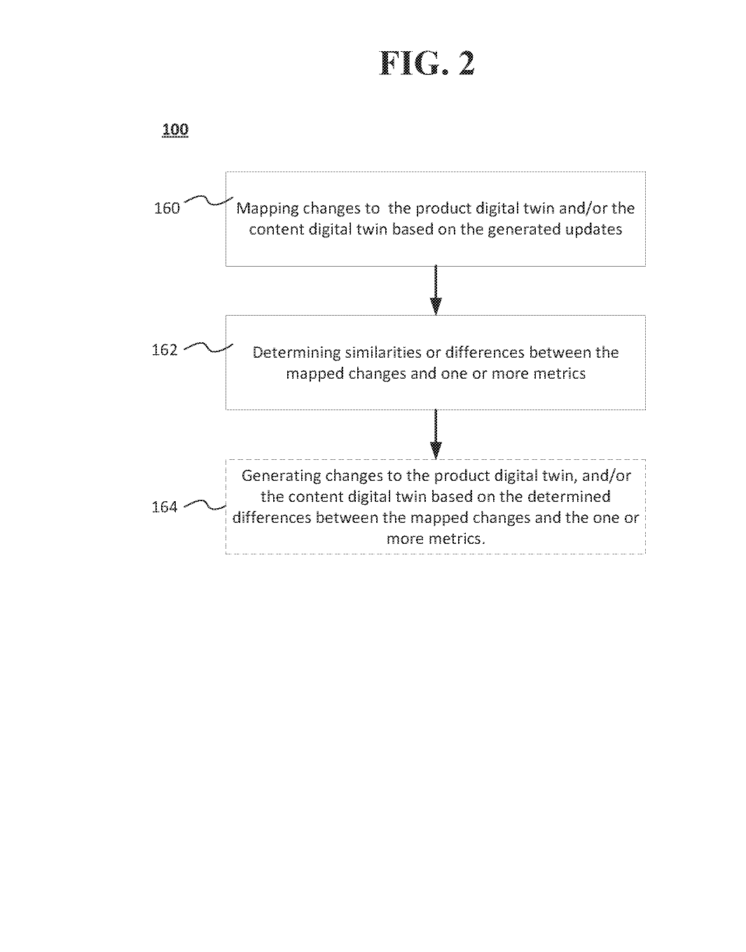

FIG. 2 shows additional optional operations of method 100 according to implementations of the disclosed subject matter. At operation 162, the server may map changes to the product digital twin and/or the content digital twin based on the generated updates. For example, the product digital twin (e.g., product digital twin 204 of FIG. 3A) of the digital twin system (e.g., digital twin system 302 of FIG. 3D) may access and/or store one or more records detailing changes and/or updates to product attributes, features, and the like that may be received (e.g., from a PIM 304 of FIG. 3D). In another example, the content digital twin (e.g., content digital twin 206 of FIG. 206) that may be part of the digital twin system (e.g., digital twin system 302 of FIG. 3D) may access and/or store one or more records detailing changes to content and/or narratives (e.g., operation 23 of FIG. 3A to modify the product narrative as described below), the generation of a new product narrative (e.g., at operation 228 of FIG. 3A as described below), changes to the content and/or narratives based on key events identified by the listening engine (e.g., operations 212 and 214 of FIG. 3A, and the operations shown in FIG. 3C and described below), from data received by the CMS (e.g., CMS shown in FIG. 3D), and the like.

At operation 162, the server may determine similarities and/or differences between the mapped changes and one or more metrics. In some implementations, the server and/or the AI system may generate changes based on the product digital twin and/or the content digital twin based on the determined differences between the mapped changes and the one or more metrics at operation 164. For example, the metric may be product metric goal 222 shown in FIG. 3A, and operation 218 of FIG. 3A may identify the differences between key events from interactions with content and the metric goal to generate the product impact data 220 as described in detail below.

FIGS. 3A-3C show example operations 200 in a system that includes a digital twin system (e.g., digital twin system 302 shown in FIG. 3D) having a product digital twin 204 and content digital twin 206 according to implementations of the disclosed subject matter. The operations 200 may provide consistent information across different platforms that may be personalized for a user. In some implementations, the digital twin system may be part of server 700 shown in FIG. 4, where product data and/or content data may be stored, for example, at database 710.

As described above in connection with FIGS. 1-2, product digital twin 204 shown in FIG. 3A may be a virtual representation of a physical product that is designed to accurately reflect the characteristics, behavior, and/or lifecycle of the product throughout its existence. The product digital twin 204 may be a real-time counterpart to a physical product, and continuously receiving data from the product itself and/or from simulations to enhance its accuracy and relevance.

Content digital twin 206 may be a virtual representation of a piece of content that dynamically adapts to reflect real-time data, user interactions, and/or contextual information, as described in detail above in connection with FIGS. 1-2.

In some implementations, the product digital twin 204 and/or the content digital twin 206 may store historical change information, which may be used to map their evolution without deletion and/or removal of the historical data. The product digital twin 204 and/or the content digital twin 206 may interact in real time with external data.

Product data attribute 202 may be a product feature of the product digital twin 204 that may be emphasized in a narrative of the content of the product in the content digital twin 206. For example, the product data attribute may be a technical specification, size, color, performance results, independent review of the product, or the like that may be emphasized to a user or group of users. The product data attribute 202 may be transmitted to product narrative data point 208 (e.g., where a narrative is generated for presentation to the user based on the product data attribute 202, as described in detail below) and/or product metric goal 222.

Product metric goal 222 may be a metric used to determine the performance of the product based at least on product data attribute 202. For example, the product metric goal 222 may be to minimize the number of user interactions with a web site and/or mobile app before the user arrives at information, product, or the like that the user is interested in. In another example, the product metric goal may be to increase test scores for a user of an educational product. In another example, the metric may be to increase the number of sales of the product after a user views a narrative or content for the product.

Product narrative data point 208 may be a narrative of content for a product (e.g., of the content digital twin) that is based on the product data attribute 202. For example, the narrative may be changed and/or updated to emphasize the technical specification, size, color, performance results, independent review, or the like to a user or group of users.

At operation 210, the product narrative may be published on a plurality of different platforms (e.g., one or more platforms 780 shown in FIG. 4) which may include, for example, web sites, one or more social media sites, mobile apps, emails, or the like.

At operation 240 shown in FIG. 3B, the product narrative data point 208 may be used to determine whether the product narrative is important to the user. For example, operation 240 may make this determination based on the number of interactions or lack of interactions of the user with the product, product narrative, or the like that is published on one or more platforms. If the narrative with the narrative data point is determined to be not important to the user, a narrative for the product that is not personalized for a particular user may be published on a plurality of different platforms at operation 210 of FIG. 3A. For example, a default and/or predetermined narrative may be displayed for the used. If the narrative (i.e., with the narrative data point) is determined to be important to the user at operation 240, a personalized view of the narrative may be provided to the user at operation 242. For example, the one or more platforms 780 that may publish the narrative may transmit the narrative to the computer 500 (i.e., the user’s device) as shown in FIG. 4. In some implementations, the personalized view of a narrative for the product may be displayed for the user at operation 242 without determining whether the product narrative is important to the user at 240.

The user, a group of users, or others may interact with the published product narrative as shown in operation 212 of FIG. 3A. For example, there may be one or more social media posts about the product narrative that are published on the one or more platforms 780 shown in FIG. 4, which may be transmitted to the user’s device (e.g., computer 500 shown in FIG. 4).

At operation 214, a listening engine may identify key events from interactions with the published product narrative. The listening engine may be part of server 700 shown in FIG. 4, and may monitor the events of the more of more platforms 780. The listening engine may identify events such as interaction with the published product narrative at operation 212.

FIG. 3C shows an example operation of the listening engine. Endpoint channel 250 may provide interaction data to an interaction layer 252 of the listening engine, which may monitor interactions for one or more channels (e.g., one or more platforms 780 shown in FIG. 4). The endpoint channel 250 may be one or more servers that displays a web page, displays a social media channel, generates an email, or the like that a user or a group of users may interact with. The endpoint channel 250 may be one of the channels that an interaction at operation 212 was received from.

At operation 254, the interactions received by the interaction layer 252 may be interpreted to identify key events of the interactions. For example, natural language processing (e.g., using natural language processing system 770 shown in FIG. 4) may be used to interpret the interactions made by one or more users that are received at the interaction layer 252, and determine whether the interactions exceed a predetermined interaction threshold at operation 256, as discussed below. The interaction threshold may be based on the type of interaction, the content of the interaction (e.g., comments made by a user about a product on a web site or social media), or the like.

At operation 256, the listening engine may determine whether one or more of the key events of the interactions meet a predetermined threshold for updating the narrative of the product to tailor it to a user or group of users. That is, the content may be updated based on some interactions, while other interactions with the content may not be determined to be significant enough to update the content. In some implementations, the predetermined threshold may be based on the product metric goal 222, a classification of the user that is interacting with the content (e.g., the interaction by one or more users may be weighted relative to other users), the type of interaction between the user and the content (e.g., a positive social media post about the product based on the content, purchasing a product based on viewing the content), and the like. At operation 258, the content may be updated based on the interactions, and the updated content may be stored in a content system (e.g., system 300 shown in FIG. 3D which may perform the operations 200 shown in FIGS. 3A-3B). The updated content may be transmitted to the endpoint channel (e.g., one or more platforms 780 shown in FIG. 4), where the user or group of users may interact with the updated content.

At operation 216 shown in FIG. 3A, a predictive engine of the server may correlate one or more of the identified key events to the product metric goal 222. The predictive engine may be part of server 700 or a different server communicatively coupled to communications network 600 of FIG. 4. At operation 218, the difference (i.e., delta) between the identified key events and the product metric goal may be determined by the server. At operation 220, data representing the difference between the identified key events and the product metric goal may be generated based on the determination at operation 218.

At operation 224, the server may determine if the content (which may include the narrative) has made progress in achieving the product metric goal. When the content for the product has made progress in achieving the product metric goal, the product narrative may be maintained at operation 226. Although one or more elements of the product narrative may be maintained at operation 226, new product narrative data for other elements of the product narrative may be generated at operation 228. The new product narrative data may be provided to the product narrative data point, which may used by the content digital twin. For example, there may be a core narrative that may evolve, and there may be a personalized narrative that may change based on who is viewing the product narrative.

When the content for the product has not made progress in achieving the product metric goal, the product narrative may be modified by the server at operation 230 based at least in part on the product metric goal for a new point and/or based on the product impact data 220. At operation 228, a new narrative may be generated by a generative engine of the server to increase progress towards the product metric goal. The new product narrative may be provided to product narrative data point 208 and may be published on a plurality of platforms at operation 210. The product narrative data point 208 may be part of the content digital twin (e.g., content digital twin 206), in that the product narrative data point is a data point within the content digital twin. The new product narrative that is generated at operation 228 may be provided to the product narrative data point 208. The content digital twin 206 may use the new product narrative of the product narrative data point when interacting with other systems (e.g., the content digital twin of the digital twin system 302 may interact with, for example, the integration layer 308 and the customer system 316, and the like).

FIG. 3D shows example system 300 which may perform method 100 shown in FIGS. 1-2 and/or the operations of the information flow 200 shown in FIGS. 3A-3C. As shown in FIG. 3D, the digital twin system 302 of system 300 may be communicatively coupled to different components, which may be configured to create a unified experience for a user or group of users according to implementations of the disclosed subject matter.

The digital twin system 302 may include a product digital twin (e.g., product digital twin 204 shown in FIG. 3A) that is a dynamically updatable virtual representation of a product, and a content digital twin (e.g., content digital twin 206 shown in FIG. 3A) that is a dynamically updatable content for the product. The digital twin system may be part of server 700 shown in FIG. 4. The digital twin system 302 may access and/or receive product data from Product Information Management (PIM) system 304 described below to update the digital product models, and may combine the product data with dynamic, real-time operational data received from one or more data sources to generate a comprehensive product representation. That is, data from the PIM system 304 may be used to define the initial characteristics of one or more products for the digital twin system 302.

The digital twin system 302 may allow content to evolve in real-time by continuously updating and/or optimizing itself based on user interactions and contextual data. This ability to mirror and/or adapt content dynamically differs from traditional content management systems (CMS), which typically require manual intervention for updates. That is, the digital twin system 302 may change based on real-time data, unlike present systems that only have static content. The digital twin system 302 may be updated based on user interactions and/or contextual data received from one or more data sources.

PIM system 304 may be a server and/or part of a server (e.g., server 700 shown in FIG. 4 or another server that is communicatively coupled to network 600) that may store (e.g., in database 710 or another database communicatively coupled to network 600) and/or manage product information. The PIM system 304 may store static product data (e.g., descriptions, specifications, images, pricing, and the like). The PIM system 304 may be used to ensure the accuracy and/or consistency of the product data across different platforms and/or channels. The PIM system 304 may receive data from the digital twin system 302, where the received data may be used to update the product specifications, user behavior and/or interaction patterns, product support information, and the like.

Content Management System (CMS) 306 may be a server and/or part of a server (e.g., server 700 shown in FIG. 4 or another server that is communicatively coupled to network 600) that may be used to generate, edit, and/or organize digital content and/or information.

As shown in FIG. 3D, the integration layer 308 may be used to connect one or more data sources and/or systems. Integration layer 308 may be a server and/or part of a server (e.g., server 700 shown in FIG. 4 or another server that is communicatively coupled to network 600). Integration layer 308 may enable data flow between product catalogs, content management systems (CMS), and/or one or more data platforms. In implementations of the disclosed subject matter, this end-to-end integration may be used to create a cohesive customer journey across all channels and/or data platforms. By unifying product and content data, implementations of the disclosed subject matter may provide a user or group of users with more engaging and/or relevant content.

The customer data platform 310 may be communicatively coupled to the commerce platform to generate personalized recommendations for a user to direct the user to products, information, educational resources, and the like. The customer data platform 310 may be a server and/or part of a server (e.g., server 700 shown in FIG. 4 or another server that is communicatively coupled to network 600).

The commerce platform 312 may use integrated data from integration layer 308 to deliver personalized experiences (e.g., presentation and arrangement of data, information, products, and the like to a user or group of users). The commerce platform 312 may be part of server 700 shown in FIG. 4, or another server that is communicatively coupled to network 600. The commerce platform 312 may manage one or more digital product catalogs, and may track user interactions (e.g., interactions with the data, information, products, and the like).

The automation engine 314 may be a separate server or part of server 700 that may be configured to use product and/or user data to generate and transmit personalized messages to users regarding products, educational information and/or resources, and other information.

Customer system 316 may be a separate server or part of server 700 that may be configured to track and/or store (e.g., in database 710 shown in FIG. 4) user interactions across one or more platforms and/or touchpoints (e.g., interactions with one or more platforms 780 and/or computer 500 shown in FIG. 4) to generate a profile of one or more users.

As shown in FIG. 3D, customer system 316 may provide feedback to the digital twin system 302. That is, user interactions and/or engagement metrics from customer system 316 may be transmitted to the digital twin system 302. This feedback loop allows for the content and/or narrative to be continuously updated, which may provide increased personalization for a user over time.

FIG. 3D shows that different data sources data, which may provide user behavior data, environmental context (e.g., location and device), and/or external conditions, and the like may be used to provide feedback to the digital twin system 302 to enable changes to content based on the received data.

The following may be an example using the method 100 shown in FIGS. 1-2, the operations 200 shown in FIGS. 3A-3C, and/or the example system 300 shown in FIG. 3D. A jacket manufacturer may be launching a new winter jacket collection via the jacket manufacturer’s website, and/or via social media, an email campaign, and/or via the manufacturer’s app that users may have downloaded to a mobile device (e.g., computer 500 shown in FIG. 4). For example, the new winter jacket may be made with eco-friendly insulation, waterproof fabrics, and/or tailored fits for different activities, sports, lifestyles, temperature ranges, and the like.

Historically, such launches by the jacket manufacturer required weeks of manual data collection and content creation. In contrast, the digital twin system 302 shown in FIG. 3D and operations 200 shown in FIGS. 3A-3C and described above may be used to generate, publish, update, and/or receive feedback on the new winter jacket collection to reduce time and/or resources used. The content digital twin 206 and the dynamic product narrative (e.g., a product narrative that may be changed based on user interactions 212, and/or may modify product narrative at operation 230, generate new a product narrative at operation 228, and the like) may be integrated with the product digital twin 204.

Beginning with the initial design of the jackets, the product digital twin 204 may store a plurality of details about the jacket collection. For example, the details of the jacket collection may be part of product data attributes 202 shown in FIG. 3A, and/or stored in the PIM system 304. The details about the jacket collection may include, for example, fabric specifications and/or type (waterproof, breathable, elastic, and the like), types of hoods (e.g., cinchable hoods, hoods that will accommodate a ski, bike, and/or climbing helmet, or the like), pit zips, number of pockets, location of pockets (e.g., interior, exterior, and the like), adjustment cords, cuff type (e.g., elastic, hook and loop closure, and the like), dimensions for each size of jacket, regional availability, insulation material, recommended temperature range, and the like. These are merely examples of product data attributes that may be stored, and other suitable product data attributes that may relate to a jacket collection may be stored.

Instead of uploading product details manually as done previously, the product digital twin 204 may include the information from the design phase (e.g., the product attributes). The information from the design phase may include, for example, materials, sizes, target personas (e.g., types of users or applications (e.g., sport, activity, or the like) that the jacket may be suitable for, and/or even sustainability certifications. The product digital twin 204 may communicate directly with the content digital twin 206. The digital twin system 302 may dynamically generate tailored content for one or more platforms using the product details from the product digital twin 204. For example, the product narrative may be generated at operation 208. It may be determined whether the generated product narrative is important to the user at operation 240, and a personalized view of the content (i.e., generated product narrative) may be provided at operation 242. The product narrative may be published on a plurality of different platforms at operation 210 (e.g., one or more platforms 780 shown in FIG. 4 and discussed below).

In an example of tailored content, users who are adventure enthusiasts may view a social media site, such as one of the platforms 780 that published a product narrative at operation 210. The user may be presented with content which features rugged, waterproof jackets modeled on snowy peaks, where these product narrative data points were determined to be important to the user at operation 240. The content which features rugged, waterproof jackets may be shown to these users at operation 242, as this may be a personalized view of the content for the users. This type of content may have been determined to be relevant to the adventure enthusiast users at operation 240.

Continuing the example of tailored content, city commuter users may receive an email from an email campaign of the manufacturer which may show sleek, lightweight jacket designs for urban winters. These users may be visiting the same platform or a different platform than the adventure enthusiasts. It may be determined that the sleek, lightweight designs for urban commuting are important to the users at operation 240, and a personalized email is transmitted to the users at operation 242.

As real-time data flows in (e.g., at listening engine to identify key events at operation 214, product impact data 220, and the like), the digital twin system 302 may automatically adjust content to promote high-demand items or push discounts on slower-moving styles and/or models of the jacket lineup. For example, the product narrative may be modified at operation 230 to a new point (e.g., promote an in-demand item, promote new pricing, or the like) and/or new product narrative data may be generated at operation 228. The new and/or modified product narrative may be published on a variety of platforms at operation 210. That is, users may receive personalized, consistent, and/or engaging content across all touchpoints (e.g., websites, apps, social media sites, email, and the like).

In the traditional CMS workflow, members of the jacket manufacturer team would need to manually input product details into the CMS and ensure they were accurately reflected across different website, emails, and social media. Separate content pieces would need to be written by team members of the jacket manufacturer for each platform. The team members would need to manually adjust the content pieces when inventory or promotions changed. For example, if eco-conscious customers suddenly showed interest in the collection’s sustainability features, the team would need to update the messaging in the content. This may take time, which may mean that the jacket manufacturer may not be able to provide the updated content to potential users and/or customers. Mismatched or outdated product information across channels may frustrate customers, and/or lead to lost sales opportunities.

In the system of the disclosed subject matter, the product digital twin 204 of the digital twin system 302 may provide comprehensive product data to the content digital twin 206, and a product narrative may be generated at operation 208. The digital twin system 302 may automate processes (e.g., such as those of the CMS workflow), and may use generative AI system 750 and/or ML system 760 as shown in FIG. 4 and described below to reduce and/or eliminate manual work performed by team members. The digital twin system 302 dynamically adjust to real-time data (e.g., modify the product narrative data at operation 230 and/or generate new product narrative data at operation 228), and/or may provide a unified and engaging customer experience (e.g., by determining whether a product narrative is important to a user at operation 240 and/or providing a personalized view of content to the user at operation 242). This integrated approach maximizes engagement, conversions, and/or user satisfaction in providing the users with the information and/or content they need.

Implementations of the disclosed subject matter may be implemented in and used with a variety of component and network architectures. FIG. 4 is an example computer 500 may allow a user to interact with the server 700 (or one or more other servers communicatively coupled to communications network 600) that is suitable for the operations detailed in FIGS. 1-3C, and which may be part of system 300 shown in FIG. 3D. Although one server 700 is shown in FIG. 4, there may be a plurality of servers communicatively coupled to communications network 600 to perform the operations detailed in FIGS. 1-3C and be part of the system of FIG. 3D. The computer 500 may be a single computer in a network of multiple computers.

In some implementations, the computer 500 may communicate with and may be used to receive one or more responses generated by server 700, database 710, generative AI system 750, machine learning (ML) system 760, natural language processing system 770, and/or one or more platforms 780 via communications network 600. The server 700, generative AI system 750, ML system 760, natural language processing system 770, and/or one or more platforms 780 may be one or more hardware servers, virtual machines, cloud servers, databases, clusters, application servers, neural network systems, processors, devices, computers, or the like. Although one server 700, database 710, generative AI system 750, ML system 760, natural language processing system 770, and/or one or more platforms 780 there may be a plurality of servers and or databases communicatively coupled to communications network 600 which may operate in concert with one another. The database 710 may use any suitable combination of any suitable volatile and non-volatile physical storage mediums, including, for example, hard disk drives, solid state drives, optical media, flash memory, tape drives, registers, and random access memory, or the like, or any combination thereof. The database 710 may store data, such as tenant data (e.g., in a multi-tenant database system), content data, product data, user profile data, product digital twin data, content digital twin data, content data, narrative data, product metric goals, product data attributes product narrative data points, metadata, application data, and the like. The generative AI system 750, the ML system 760, and/or the natural language processing system 770 may generate the updates for the content digital twin, update a narrative, predict user engagement trends, and/or change structure, style, tone, style, and/or language of the content to tailor it to a user or group of users, and the like as described in detail above.

The computer (e.g., user computer, enterprise computer, or the like) 500 may include a bus 510 which interconnects major components of the computer 500, such as a central processor 540, a memory 570 (typically RAM, but which can also include ROM, flash RAM, or the like), an input/output controller 580, a user display 520, such as a display or touch screen via a display adapter, a user input interface 560, which may include one or more controllers and associated user input or devices such as a keyboard, mouse, Wi-Fi/cellular radios, touchscreen, microphone/speakers and the like, and may be communicatively coupled to the I/O controller 580, fixed storage 530, such as a hard drive, flash storage, Fibre Channel network, SAN device, SCSI device, and the like, and a removable media component 550 operative to control and receive an optical disk, flash drive, and the like.

The bus 510 may enable data communication between the central processor 540 and the memory 570, which may include read-only memory (ROM) or flash memory (neither shown), and random-access memory (RAM) (not shown), as previously noted. The RAM may include the main memory into which the operating system, development software, testing programs, and application programs are loaded. The ROM or flash memory can contain, among other code, the Basic Input-Output system (BIOS) which controls basic hardware operation such as the interaction with peripheral components. Applications resident with the computer 500 may be stored on and accessed via a computer readable medium, such as a hard disk drive (e.g., fixed storage 530), an optical drive, floppy disk, or other storage medium 550.

The fixed storage 530 can be integral with the computer 500 or can be separate and accessed through other interfaces. The fixed storage 530 may be part of a storage area network (SAN). A network interface 590 can provide a direct connection to a remote server via a telephone link, to the Internet via an internet service provider (ISP), or a direct connection to a remote server via a direct network link to the Internet via a POP (point of presence) or other technique. The network interface 590 can provide such connection using wireless techniques, including digital cellular telephone connection, Cellular Digital Packet Data (CDPD) connection, digital satellite data connection or the like. For example, the network interface 590 may enable the computer to communicate with other computers and/or storage devices via one or more local, wide-area, or other networks. The service resource 404 and/or one or more user devices 750 may have components that are similar to the computer 500 described above.

Many other devices or components (not shown) may be connected in a similar manner (e.g., data cache systems, application servers, communication network switches, firewall devices, authentication and/or authorization servers, computer and/or network security systems, and the like). Conversely, all the components shown in FIG. 4 need not be present to practice the present disclosure. The components can be interconnected in different ways from that shown. Code to implement the present disclosure can be stored in computer-readable storage media such as one or more of the memory 570, fixed storage 530, removable media 550, or on a remote storage location.

Some portions of the detailed description are presented in terms of diagrams or algorithms and symbolic representations of operations on data bits within a computer memory. These diagrams and algorithmic descriptions and representations are commonly used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all these and similar terms are to be associated with the appropriate physical quantities and are merely convenient labels applied to these quantities. Unless specifically stated otherwise as apparent from the above discussion, it is appreciated that throughout the description, discussions utilizing terms such as “generating”, “receiving”, “transmitting”, “updating”, “personalizing”, “mapping”, “determining”, “formatting”, or the like, refer to the actions and processes of a computer system, or similar electronic computing device, that manipulates and transforms data represented as physical (e.g., electronic) quantities within the computer system’s registers and memories into other data similarly represented as physical quantities within the computer system memories or registers or other such information storage, transmission or display devices.

More generally, various implementations of the presently disclosed subject matter can include or be implemented in the form of computer-implemented processes and apparatuses for practicing those processes. Implementations also can be implemented in the form of a computer program product having computer program code containing instructions implemented in non-transitory and/or tangible media, such as hard drives, solid state drives, USB (universal serial bus) drives, CD-ROMs, or any other machine readable storage medium, wherein, when the computer program code is loaded into and executed by a computer, the computer becomes an apparatus for practicing implementations of the disclosed subject matter. Implementations also can be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium can be implemented by a general-purpose processor, which can transform the general-purpose processor or a device containing the general-purpose processor into a special-purpose device configured to implement or carry out the instructions. Implementations can be implemented using hardware that can include a processor, such as a general-purpose microprocessor and/or an Application Specific Integrated Circuit (ASIC) that implements all or part of the techniques according to implementations of the disclosed subject matter in hardware and/or firmware. The processor can be coupled to memory, such as RAM, ROM, flash memory, a hard disk or any other device capable of storing electronic information. The memory can store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described to explain the principles of implementations of the disclosed subject matter and their practical applications, to thereby enable others skilled in the art to utilize those implementations as well as various implementations with various modifications as can be suited to the particular use contemplated.

1. A method comprising:
generating, at a server, a product digital twin that is a virtual representation of a product, wherein the product digital twin is dynamically updatable;
generating, at the server, a content digital twin that is a virtual representation of content for the product that is dynamically updatable;
receiving, at the server, data from at least one source;
generating updates, at the server, for at least one selected from a group consisting of: the product digital twin, and the content digital twin based on the received data; and
transmitting, at the server, the generated updates to a plurality of different platforms.

2. The method of claim 1, wherein the receiving the data comprises:
receiving, from at least one data source, the data that includes at least one selected from a group consisting of: user interactions, behavioral analytics, contextual information, and external data feeds, market trend information, social media data, product data from a product information management (PIM) system, and content data from a content management system (CMS).

3. The method of claim 1, wherein the generating updates comprises:
updating, at the server, the digital product twin based on data received from at least one selected from a group consisting of: an actual product that the digital product twin is a virtual representation of, and product simulation data.

4. The method of claim 1, wherein the generating updates comprises:
generating updates, at the server, for the content digital twin based on the received data when the received data meets a predetermined metric or threshold.

5. The method of claim 1, wherein the generating updates further comprises:
generating updates, at the server, for the content digital twin based on received data from at least one selected from a group consisting of: real-time data, user interaction data, and contextual information.

6. The method of claim 1, wherein the plurality of different platforms include at least one selected from a group consisting of: websites, social media sites, mobile applications, and email messages.

7. The method of claim 1, wherein the generating updates comprises:
generating updates, at an artificial intelligence system or machine learning system that is part of or communicatively coupled to the server, for the content digital twin based on at least a portion of the received data.

8. The method of claim 1, wherein the generating updates comprises:
personalizing, at the server, the content digital twin for a user or a group of users based on the received data.

9. The method of claim 1, further comprising:
mapping, at the server, changes to at least one selected from the group consisting of: the product digital twin, and the content digital twin based on the generated updates; and
determining, at the server, similarities or differences between the mapped changes and one or more metrics.

10. The method of claim 9, further comprising:
generating, at the server or an artificial intelligence system communicatively coupled to the server, changes to at least one selected from the group consisting of: the product digital twin, and the content digital twin based on the determined differences between the mapped changes and the one or more metrics.

11. The method of claim 1, further comprising:
formatting the generated updates for the plurality of different platforms.

12. A system comprising:
a server configured to:
generate a product digital twin that is a virtual representation of a product, wherein the product digital twin is dynamically updatable;
generate a content digital twin that is a virtual representation of content that dynamically updates;
receiving data from at least one source communicatively coupled to the server;
generate updates for at least one selected from a group consisting of: the product digital twin, and the content digital twin based on the received data; and
transmit the generated updates to a plurality of different platforms.

13. The system of claim 12, further comprising:
at least one data source communicatively coupled to the server,
wherein the server is configured to receive data from the at least one data source that includes at least one selected from a group consisting of: user interactions, behavioral analytics, contextual information, and external data feeds, market trend information, social media data, product data from a product information management (PIM) system, and content data from a content management system (CMS).

14. The system of claim 12, wherein the server is configured to update the digital product twin based on data received from at least one selected from a group consisting of: an actual product that the digital product twin is a virtual representation of, and product simulation data.

15. The system of claim 12, wherein the server is configured to generate updates for the content digital twin based on the received data when the received data meets a predetermined metric or threshold.

16. The system of claim 12, wherein the server is configured to generating updates for the content digital twin based on received data from at least one selected from a group consisting of: real-time data, user interaction data, and contextual information.

17. The system of claim 12, wherein the plurality of different platforms include at least one selected from a group consisting of: websites, social media sites, mobile applications, and email messages.

18. The system of claim 12, further comprising:
An artificial intelligence system or machine learning system communicatively coupled to the server,
wherein the server, artificial intelligence system, or machine learning system is configured to generates updates for the content digital twin based on at least a portion of the received data.

19. The system of claim 12, wherein the server is configured to personalize the content digital twin for a user or a group of users based on the received data.

20. The system of claim 12, wherein the server is configured to map changes to at least one selected from the group consisting of: the product digital twin, and the content digital twin based on the generated updates, and
wherein the server is configured to determine similarities or differences between the mapped changes and one or more metrics.

21. The system of claim 20, wherein the server or an artificial intelligence system communicatively coupled to the server is configured to generate changes to at least one selected from the group consisting of: the product digital twin, and the content digital twin based on the determined differences between the mapped changes and the one or more metrics.

22. The system of claim 12, wherein the server is configured to format the generated updates for the plurality of different platforms.
